(19) United States
(12) Patent Application Publication
(10) Pub. No.: US 2011/0279748 A1
(43) Pub. Date: Nov. 17, 2011

(54) LIQUID CRYSTAL DISPLAY DEVICE

(75) Inventor: Makoto HASEGAWA, Chosei-gun (JP)

(73) Assignees: Panasonic Liquid Crystal Display Co., Ltd.; Hitachi Displays, Ltd.

(21) Appl. No.: 13/104,163

(22) Filed: May 10, 2011

(30) Foreign Application Priority Data
May 11, 2010 (JP) 2010-109249

(51) Int. Cl. G02F 1/1333

(52) U.S. Cl. 349/58

(57) ABSTRACT

A liquid crystal display device includes: a resin frame including a hole passing through first and second surfaces thereof, the first surface including a first recess formed around the hole, the second surface including a second recess formed around the hole; a liquid crystal display panel fixed to the first surface of the resin frame; a light guide plate fixed to the second surface of the resin frame; a flexible wiring substrate connected to the liquid crystal display panel; and an electronic component mounted on the flexible wiring substrate, in which the liquid crystal display panel is arranged so that an end thereof is positioned in a state of being held above the first recess, the flexible wiring substrate is arranged to extend from the first surface side to the second surface side while being bent, and the electronic component is received in the second recess.

### CROSS-REFERENCE TO RELATED APPLICATION

The present application claims priority from Japanese application JP 2010-109249 filed on May 11, 2010, the content of which is hereby incorporated by reference into this application.

### BACKGROUND OF THE INVENTION

1. Field of the Invention

The present invention relates to a liquid crystal display device.

2. Description of the Related Art

There has been known a liquid crystal display device having a structure in which an end of a liquid crystal display panel is bonded to a resin frame (see Japanese Patent Application Laid-open No. 2008-170739). In recent years, the liquid crystal display panel has been reduced in thickness, and further the liquid crystal display device has been reduced in total thickness.

The liquid crystal display panel has reduced in strength due to its reduced thickness, and the liquid crystal display device has become easier to bend due to the reduced total thickness. Therefore, it has become difficult to prevent the liquid crystal display panel from being damaged.

### SUMMARY OF THE INVENTION

It is an object of the present invention to provide a liquid crystal display device capable of preventing a liquid crystal display panel from being damaged.

(1) According to the present invention, there is provided a liquid crystal display device, including: a resin frame including a hole passing through a first surface and a second surface thereof, the first surface including a first recess formed around the hole, the second surface including a second recess formed around the hole; a liquid crystal display panel fixed to the first surface of the resin frame; a light guide plate fixed to the second surface of the resin frame; a flexible wiring substrate connected to the liquid crystal display panel; and an electronic component mounted on the flexible wiring substrate, in which the liquid crystal display panel is arranged so that an end thereof is positioned in a state of being held above the first recess, the flexible wiring substrate is arranged to extend from the first surface side and to the second surface side while being bent, and the electronic component is received in the second recess. According to the present invention, the end of the liquid crystal display panel is positioned in the state of being held above the first recess. Therefore, it is possible to prevent the liquid crystal display panel from being brought into contact with the resin frame, and to prevent the liquid crystal display panel from being damaged.

(2) In the liquid crystal display device as described in item (1), the first surface may include a projection formed outside the first recess, and the second recess may be formed on an opposite side to the projection.

(3) In the liquid crystal display device as described in item (1) or (2), the first recess and the second recess may communicate to each other.

### BRIEF DESCRIPTION OF THE DRAWINGS

In the accompanying drawings:

FIG. 1 is a plan view illustrating a liquid crystal display device according to an embodiment of the present invention;

FIG. 2 is a cross-sectional view taken along the line II-II of the liquid crystal display device illustrated in FIG. 1;

FIG. 3 is a cross-sectional view taken along the line III-III of the liquid crystal display device illustrated in FIG. 1;

FIG. 4 is a view illustrating an effect of this embodiment; and

FIG. 5 is a view illustrating a modified example of the embodiment of the present invention.

### DETAILED DESCRIPTION OF THE INVENTION

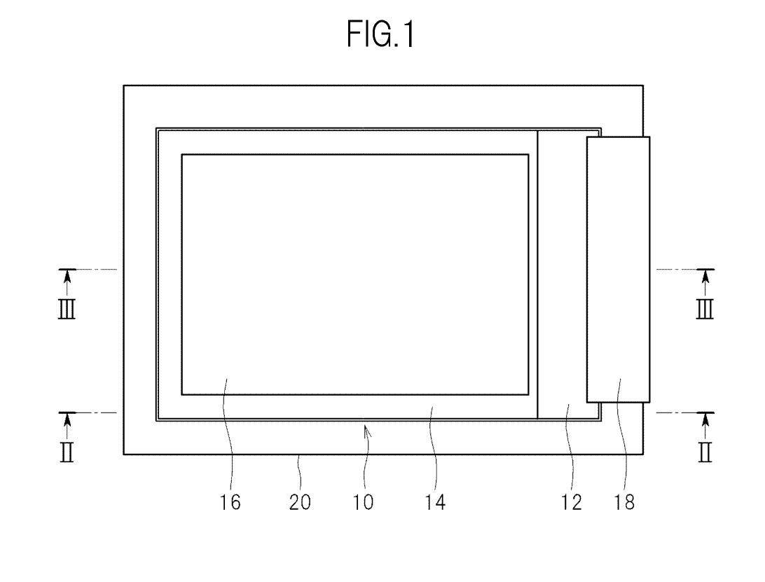

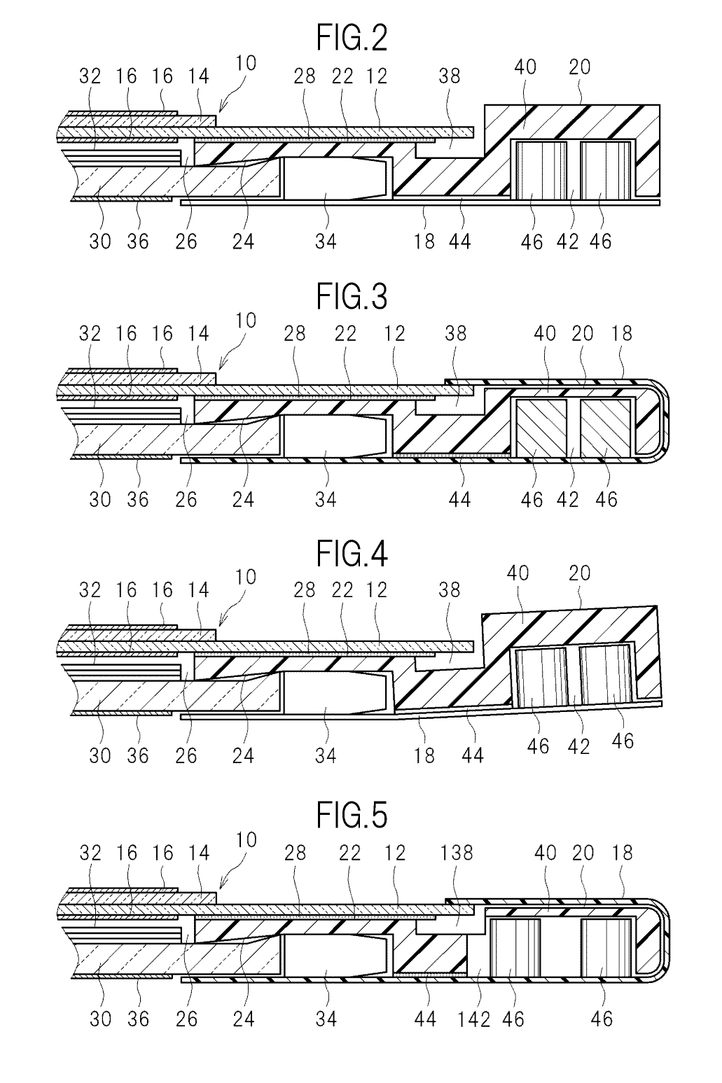

Hereinafter, an embodiment of the present invention is described with reference to the accompanying drawings. FIG. 1 is a plan view illustrating a liquid crystal display device according to an embodiment of the present invention. FIG. 2 is a cross-sectional view taken along the line II-II of the liquid crystal display device illustrated in FIG. 1. FIG. 3 is a cross-sectional view taken along the line III-III of the liquid crystal display device illustrated in FIG. 1.

The liquid crystal display device includes a liquid crystal display panel 10. The liquid crystal display panel 10 includes a pair of substrates 12 and 14 made of a glass or the like, and liquid crystal (not shown) sandwiched between the pair of substrates 12 and 14, and one substrate 12 is formed to be longer than the other substrate 14. To each of the pair of substrates 12 and 14, a polarization plate 16 is bonded.

The liquid crystal display panel 10 is connected to a flexible wiring substrate 18. Specifically, the one substrate 12 is electrically connected to the flexible wiring substrate 18. On the flexible wiring substrate 18, an electronic component 46 is mounted. In order to electrically connect the electronic component 46 to the liquid crystal display panel 10, the flexible wiring substrate 18 has a wiring pattern (not shown).

The liquid crystal display device includes a resin frame 20. The resin frame 20 includes a first surface 22 and a second surface 24, and a hole 26 passing through the first surface 22 and the second surface 24. The liquid crystal display panel 10 includes a display area arranged to be opposed to the hole 26 of the resin frame 20. As illustrated in FIG. 2, the entire polarization plate 16 may be positioned inside the hole 26. The liquid crystal display panel 10 is fixed to the first surface 22 of the resin frame 20. Specifically, the one substrate 12 is bonded to the first surface 22 by an adhesive material such as double-sided tape 28. The double-sided tape 28 has a light blocking property.

The liquid crystal display device includes a light guide plate 30 arranged on the second surface 24 side of the resin frame 20. The light guide plate 30 is opposed to the liquid crystal display panel 10 and also to the hole 26 of the resin frame 20. Between the liquid crystal display panel 10 and the light guide plate 30, an optical film 32 is arranged. The optical film 32 is arranged inside the hole 26. A light source such as a light emitting diode (LED) 34 is arranged to be opposed to an end surface of the light guide plate 30. On an opposite surface of the light guide plate 30 from the liquid crystal display panel 10, a reflection sheet 36 is arranged.

In the first surface 22 of the resin frame 20, a first recess 38 (or groove) is formed around the hole 26. On the first surface 22, a projection 40 is formed outside the first recess 38. The upper surface of the projection 40 is higher than a region between the hole 26 and the first recess 38 of the first surface 22. The liquid crystal display panel 10 is positioned in a state in which an end thereof is held above the first recess 38. As illustrated in FIG. 2, the end of the substrate 12 fixed to the resin frame 20 of the liquid crystal display panel 10 projects above the first recess 38. The flexible wiring substrate 18 is connected to the end projecting above the first recess 38. An end of the other substrate 14 is positioned above the first surface 22 (in a region between the hole 26 and the first recess 38).

On the other hand, in the second surface 24 of the resin frame 20, a second recess 42 is formed around the hole 26. The second recess 42 is formed on an opposite side to the projection 40 of the first surface 22. The flexible wiring substrate 18 is arranged to extend from the first surface 22 side to the second surface 24 side while being bent. The second surface 24 of the resin frame 20 and the flexible wiring substrate 18 are fixed by an adhesive material such as double-sided tape 44. The electronic component 46 is received in the second recess 42. With this structure, the liquid crystal display device is prevented from being increased in thickness due to the thickness of the electronic component 46.

FIG. 4 is a view illustrating an effect of this embodiment. According to this embodiment, the end of the liquid crystal display panel 10 is positioned in the state of being held above the first recess 38, and hence the liquid crystal display panel 10 is less likely to be brought into contact with the resin frame 20. Therefore, the liquid crystal display panel 10 may be prevented from being damaged even when the liquid crystal display panel 10 is reduced in thickness. Further, even when the resin frame 20 is formed thin and hence is easily bent in order to satisfy the demand for the reduced thickness, the first recess 38 may prevent the resin frame 20 from being brought into contact with the end of the liquid crystal display panel 10.

FIG. 5 is a view illustrating a modified example of the embodiment of the present invention. This example is different from the above-mentioned embodiment in that a first recess 138 and a second recess 142 communicate to each other. The first recess 138 and the second recess 142 overlap only partly and have non-overlapping parts. The present invention also encompasses such example.

The present invention is not limited to the above-mentioned embodiment, and various modifications may be made thereto. For example, the structure described in the embodiment may be replaced with substantially the same structure, a structure providing the same action and effect, or a structure capable of attaining the same object.

What is claimed is:

1. A liquid crystal display device, comprising:
a resin frame including a hole passing through a first surface and a second surface thereof, the first surface including a first recess formed around the hole, the second surface including a second recess formed around the hole;
a liquid crystal display panel fixed to the first surface of the resin frame;
a light guide plate fixed to the second surface of the resin frame;
a flexible wiring substrate connected to the liquid crystal display panel; and
an electronic component mounted on the flexible wiring substrate,
wherein the liquid crystal display panel is arranged so that an end thereof is positioned in a state of being held above the first recess,
wherein the flexible wiring substrate is arranged to extend from the first surface side to the second surface side while being bent, and
wherein the electronic component is received in the second recess.

2. The liquid crystal display device according to claim 1,
wherein the first surface includes a projection formed outside the first recess, and
wherein the second recess is formed on an opposite side to the projection.

3. The liquid crystal display device according to claim 2, wherein an upper surface of the projection is higher than a region between the hole and the first recess of the first surface.

4. The liquid crystal display device according to claim 1, wherein the first recess and the second recess communicate to each other.

5. The liquid crystal display device according to claim 1, further comprising double-sided tape attached to a region between the hole and the first recess of the first surface,
wherein the liquid crystal display panel is attached to the resin frame via the double-sided tape.

6. The liquid crystal display device according to claim 1,
wherein the liquid crystal display panel comprises a pair of substrates opposing to each other,
wherein one of the pair of substrates is positioned in a state in which an end thereof is held above the first recess, and
wherein another one of the pair of substrates has an end positioned above a region between the hole and the first recess of the first surface.

7. The liquid crystal display device according to claim 1, wherein the flexible wiring substrate is connected to the end of the liquid crystal display panel, which is positioned in the state of being held above the first recess.
